(19) United States
(12) Patent Application Publication
(10) Pub. No.: US 2009/0275011 A1
(43) Pub. Date: Nov. 5, 2009

(54) SESSILE STEM CELLS

(76) Inventors: Johann Eibl, Vienna (AT); Heinz Redl, Vienna (AT)

Correspondence Address: BAKER BOTTS L.L.P., 30 ROCKEFELLER PLAZA, 44TH FLOOR, NEW YORK, NY, 10112-4498, US

(21) Appl. No.: 12/368,010

(22) Filed: Feb. 9, 2009

Related U.S. Application Data
(60) Provisional application No. 61/113,063, filed on Nov. 10, 2008.

(30) Foreign Application Priority Data
Apr. 30, 2008 (AT) A 684/2008

(51) Int. Cl. A01N 1/02

(52) U.S. Cl. 435/1.1

(57) ABSTRACT

Sterile, virally safe, heterologous, homologous, isologous or autologous tissue, tissue-typed or not tissue-typed, which contains predifferentiated and/or differentiable sessile stem cells and which can be used for wound closure and/or promotion of wound healing.

### CROSS-REFERENCE TO RELATED APPLICATIONS

The present application claims priority to Austrian Patent Application No. A 684/2008, filed Apr. 30, 2008 and to U.S. Provisional Application No. 61/113,063, filed Nov. 10, 2008, the contents of which are hereby incorporated herein in their entireties.

### INTRODUCTION

The invention relates to sheets of stem cells prepared from sterile, virally safe, heterologous, homologous, isologous or autologous amnion tissue and methods of using said sheets for tissue repair.

### BACKGROUND OF THE INVENTION

Amnion is the innermost of the fetal membranes and is usually discarded after birth as a part of the placenta. However, increasing attention is paid to this tissue, since the membrane as a whole and isolated cells thereof show great promise for regenerative medicine.

Amnion tissue has many beneficial properties besides its nearly unlimited availability, the easy procurement and the low processing costs for therapeutic application: It is bacteriostatic, antiangiogenic, reduces pain, suppresses inflammation, inhibits scarring and promotes wound healing and epithelialization (Dua et al., 2004; Ganatra, 2003; Gomes et al., 2005; Hao et al., 2000). Furthermore amniotic membrane shows low or no immunogenicity (Adinolfi et al., 1982; Akle et al., 1981) and acts as an anatomical and vapor barrier (Ganatra, 2003). Because of these characteristics, amnion has been applied in surgery and wound treatment e.g. for burned skin, bedsore, ulcers (Faulk et al., 1980; Gajiwala and Gajiwala, 2004; Gruss and Jirsch, 1978; Subrahmanyam, 1995; Ward et al., 1989), ophthalmology (Tosi et al., 2005), reconstruction of artificial vagina (Dhall, 1984; Nisolle and Donnez, 1992), in head and neck surgery (Zohar et al., 1987) as well as to prevent tissue adhesion in surgical procedures of the abdomen, head and pelvis (Arora et al., 1994; Rennekampff et al., 1994; Young et al., 1991). For these applications, amniotic membrane is typically processed to a non viable form. But it is also possible to keep amnion in a partially live state (Hennerbichler et al., 2006).

Amniotic membrane is composed of a single layer of epithelial cells that reside on a basement membrane and an underlying avascular stromal layer containing stromal cells (Hoyes, 1970). Intriguingly, cells isolated from both the epithelial and stromal layers express markers of mesenchymal and embryonic stem cells (Parolini et al., 2007). Accordingly, these cells can be differentiated along different lineages, including adipogenic, osteogenic, chondrogenic, hepatic, cardiomyogenic, and neurogenic (Miki et al., 2005; Portmann-Lanz et al., 2006; Sakuragawa et al., 2004; Wolbank et al., 2007; Zhao et al., 2005) reviewed in (Parolini et al., 2007). Allogenic application seems to be feasible due to immunomodulatory characteristics of these cells. Thus, amniotic cells are able to suppress proliferation of stimulated allogenic blood cells (Wolbank et al., 2007) and several clinical trials in humans proved that allogenic transplantation of amniotic membrane or amniotic cells does not cause acute immune rejection even without immunosuppressive treatment (Akle et al., 1981; Sakuragawa et al., 1992; Scaggiante et al., 1987; Tylki-Szymanska et al., 1985; Yeager et al., 1985).

For tissue engineering, cells are usually combined with a suitable carrier substrate, i.e. a three-dimensional porous scaffold or a hydrogel. These carrier substrates have been developed from both synthetic and natural-based polymers, and should be biodegradable in order to permit integration of the new tissue into an organism (Fedorovich et al., 2007; Mano et al., 2007). Alternatively, the so called cell sheet technology was developed by Okano and co-workers (Yang et al., 2006), which allows harvesting of cultured cells as intact sheets with their deposited extracellular matrix and enables their transplantation without the use of carrier materials. Mesenchymal stem cells from adipose tissue have already been applied successfully as sheets to repair scarred myocardium after myocardial infarction in a rat model (Miyahara et al., 2006). However, production of these cell sheets involves cultivation of cells, which is time consuming, and increases the risk of contamination with pathogens.

### SUMMARY OF THE INVENTION

We have recognized that amniotic membrane constitutes a pre-formed sheet of stem cells and surprisingly could develop methods for in situ differentiation of these stem cells into various tissues without their prior isolation. Thus, we present a new straightforward protocol for the preparation of constructs for regenerative medicine within a minimal time-frame and with or without the use of a carrier matrix.

The invention is therefore directed to sterile, virally safe, heterologous, homologous, isologous or autologous amnion tissue, tissue-typed or not tissue-typed, which contains predifferentiated and/or differentiable sessile stem cells and which can be used for wound closure and/or promotion of wound healing.

### BRIEF DESCRIPTION OF THE FIGURES

FIG. 1A-B. (A) Alcian blue staining shows chondrogenic differentiation of amnion stem cells cultured in chondrogenic medium relative to control. (B) Glycosaminoglycan (GAG) in amnion stem cells cultured in various media.

FIG. 2A-C. (A) Fresh amnion; Kossa staining shows bone specific mineral deposits in amnion stem cells cultured in osteogenic medium (C) relative to control (B).

FIG. 3A-C. (A) Viability of amnion stem cells in adipogenic medium or adipogenic medium plus troglitazone (C) versus control medium. (B) Increased lipid vesicles in amnion stem cells cultured in adipogenic medium (B) relative to adipogenic medium plus troglitazone (C).

### DETAILED DESCRIPTION OF THE INVENTION

Accordingly, in certain non-limiting embodiments, the present invention provides for a composition comprising a sheet of amnion stem cells and further comprising one or more of (i) a differentiation agent; (ii) a carrier substrate; (iii) an antibiotic (e.g. ampicillin, amphotericin B, hygromycin, neomycin sulfate, Nstatin, penicillin, streptomycin, etc.) and/or (iv) an adhesive layer (e.g., fibrinogen).

In further non-limiting embodiments, the present invention provides for a method of performing wound/lesion closure and/or promoting wound/lesion healing comprising applying, to the wound/lesion, an effective amount of a sheet of amnion stem cells, and previously, concurrently or subsequently exposing said stem cells to an effective amount of a differentiation agent appropriate for the wound/lesion site.

Said sheet of amnion stem cells is preferably comprised in amnion tissue which has been separated from placenta. Said sheet is termed “virus safe” meaning that it carries minimal risk of transmitting a virus infection. Said sheet may be considered to be “virus safe” if the donor from whom the tissue is obtained has been tested and confirmed free of infection with hepatitis A, B,C,D, and E and human immunodeficiency virus.

The inventive tissue can be used in tissue engineering.

A preferred embodiment of the inventive tissue contains chondrogenic and/or osteogenic and/or adipogenic and/or angiogenic precursor cells and/or neuro precursor cells resulting from differentiation of the amnion stem cells.

A further embodiment is characterized in that substances are added in culture medium for the differentiation of stem cells or predifferentiated stem cells.

A further specific, non-limiting embodiment is characterized in that no animal additives are used in the culture medium.

A still further inventive embodiment is characterized that the adipogenic differentiation is supported by agonists of the peroxisome proliferators-activated receptor, for example, but not limited to, rosiglitazone or another thiazolidinedione such as pioglitazone and troglitazone.

A further embodiment undergoes differentiation of stem cells or predifferentiated stem cells by physical action such as stretching, compressing, fluid flow, electrical, ultrasound, and/or shock wave treatment.

In a further embodiment, amnion stem cells may be transfected with a gene of interest prior to, during, or after differentiation of stem cells.

A further embodiment is used for the construction of three-dimensional cell layers, where the latter may be used as such or may be combined by a provisional matrix.

The inventive tissue can be used for the construction of three-dimensional cell layers, where the latter may be used as such or may be combined by a provisional matrix, such as, but not limited to, a collagen or fibrin gel.

It can also be used in combination with biologically and/or synthetically produced scaffolds.

It can further be used for lining tube- or cavity-like parts of organs or constructs obtained by tissue engineering For example, in particular non-limiting embodiments the present invention provides for a sheet of amnion stem cells comprised in a section of amnion tissue, prepared by separating said amnion tissue from placenta and then optionally washing with a suitable physiologic solution, such as phosphate buffered saline (PBS).

In specific non-limiting embodiments, an amnion stem cell sheet has a width of at least about 5 mm, or at least about 10 mm, or at least about 50 mm, or at least about 100 mm and/or an area of at least about 25 mm², or 50 mm², or at least about 100 mm², or at least about 250 mm², or at least about 800 mm², depending upon the application. Said amnion stem cell sheet may be used immediately after preparation, may be pre-cultured together with a differentiating agent prior to therapeutic use, or may be stored frozen at −70° C. The present invention provides for kits comprising a sterile frozen amnion stem cell sheet (optionally applied to a supporting matrix) and optionally comprising a differentiating agent.

In non-limiting embodiments, the present invention provides for methods of repair, wound/lesion closure and/or promoting wound/lesion healing of a tissue comprising applying to said wound/lesion an effective amount of an amnion stem cell sheet under conditions such that the stem cells will differentiate into cells of a type appropriate for said tissue. As non-limiting examples, where the tissue comprises adipose cells, the stem cells may be caused to differentiate into adipose cells; where the tissue comprises bone cells, the stem cells may be caused to differentiate into osteoblasts; where the tissue comprises cartilage cells, the stem cells may be caused to differentiate into chondrocytes; where the tissue is liver, the stem cells may be caused to differentiate into hepatocytes; where the tissue is heart, the stem cells may be caused to differentiate into cardiac cells; where the tissue is nerve, the stem cells may be caused to differentiate into nerve cells, and so on. Agents to promote stem cell differentiation along these lines are known in the art, and certain working examples are provided below. And see Miki et al., 2005; Portmann-Lanz et al., 2006; Sakuragawa et al., 2004; Wolbank et al., 2007; Zhao et al., 2005 and Parolini et al. 2007). Alternatively, differentiation may occur without the administration of exogenous agents as a result of agents generated by the tissue to which the amnion stem cell sheet is applied.

In certain, non-limiting embodiments, the amnion stem cell sheet may be used in conjunction with a supporting matrix, such as, but not limited to, a collagen or other biodegradable matrix, for example Surgicel Sponceram or Collagraft. The stem cell sheet may be contacted with the supporting matrix either during the repair procedure or prior to the repair procedure. In non-limiting embodiments, the sheet may be applied to the support matrix and then cultured to promote cell migration into the matrix prior to the repair procedure.

With the following Examples embodiments of the inventive tissue are described more specifically.

### EXAMPLES

### 1) Chondrogenic Differentiation

Human placentas were collected after caesarian section and kept at 4° C. in sterile bags with Ringer lactate solution containing antibiotic/antimycotic solution (consisting of Penicillin G, streptomycin sulfate and amphotericin B) until processing. Placentas were rinsed with PBS (4° C.) to remove blood residues and amniotic membrane was peeled off the residual placenta by blunt dissection. After ten washes with PBS, amniotic membrane was dissected into appropriate pieces for differentiation (round punch biopsies of 8 mm in diameter). Chondrogenic differentiation was induced by incubation with the chondrogenic differentiation medium of Cambrex, optionally supplemented with 100 μg/l BMP-6 or 10 μg/l FGF-2. As control, DMEM 10% FCS was used.

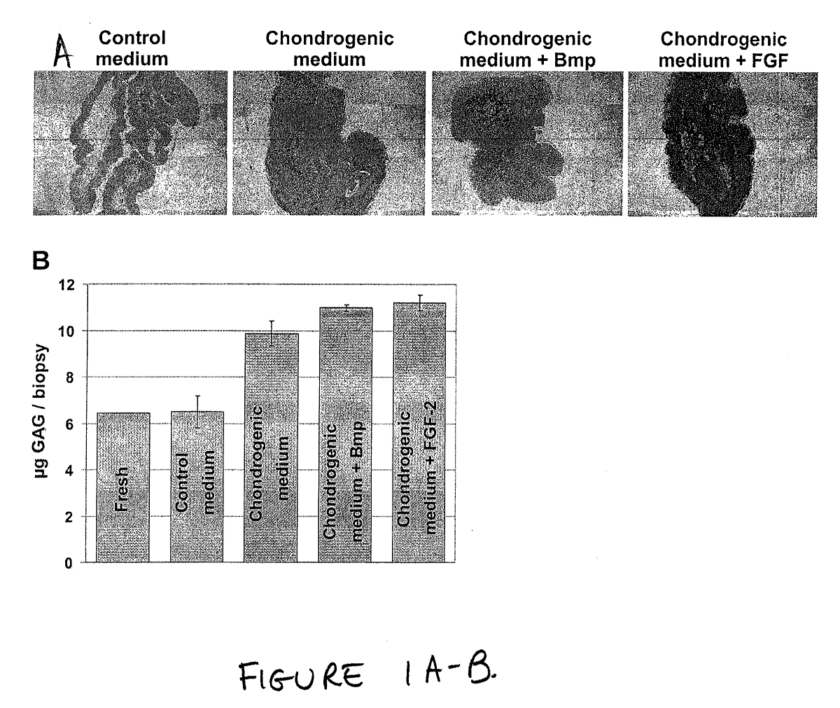

Independent of the medium, the amniotic membrane folded up with time in culture and after about two weeks compact pellets were formed. The extent of chondrogenesis was assessed by staining cartilage specific proteoglycans with alcian blue in sections of the pellets. After four weeks in culture, alcian blue staining was clearly more intense in amniotic membrane cultivated in chondrogenic medium when compared to control medium and even more pronounced when supplemented with BMP-6 or FGF-2 (FIG. 1). These data were confirmed by a quantitative assay for glycosaminoglycans (GAG), showing that GAG production is increased by cells in amniotic membrane when cultivated in chondrogenic medium, chondrogenic medium supplemented with BMP-6 and chondrogenic medium supplemented with FGF-2, in ascending order, when compared to control medium (FIG. 1).

### 2) Osteogenic Differentiation

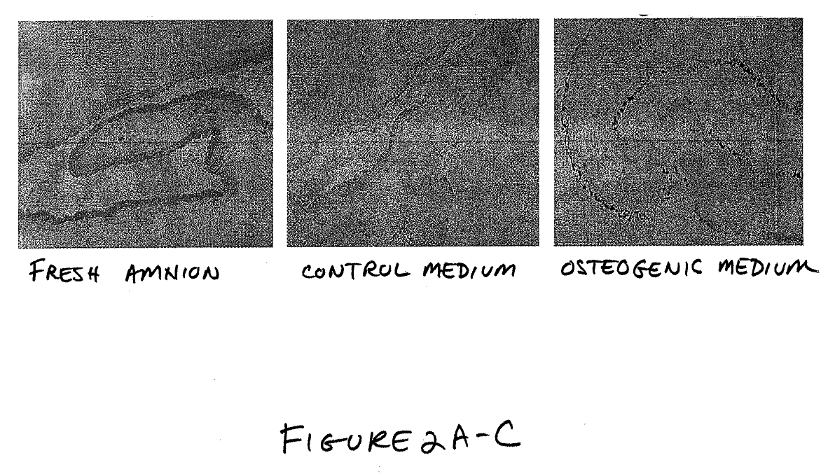

8 mm biopsies of amniotic membrane were prepared as described for chondrogenic differentiation. Osteogenic stimulation was performed with the medium DMEM containing 10% FCS, 50 μM ascorbate-2-phosphate, 0.1 μM dexamethasone, 10 nM 1,25-dihydroxy-vitamin D3, and 10 mM β-glycerophosphate. After four weeks in culture, bone-specific mineral deposition was demonstrated by von Kossa staining only in amniotic membrane cultivated in osteogenic stimulation medium and not in control medium (DMEM 10% FCS), or in fresh amniotic membrane (FIG. 2).

### 3) Adipogenic Differentiation

8 mm biopsies and 2×2 cm² pieces of amniotic membrane were cultivated in adipogenic medium consisting of DMEM-HG, 2 mM L-Gln, 10% FCS, 5.8 μg/ml insulin, 1 μM dexamethasone, 0.5 mM IBMX, and 200 μM indomethacin, with or without 1 μg/ml troglitazone (an agonist of the peroxisome proliferators-activated receptor).

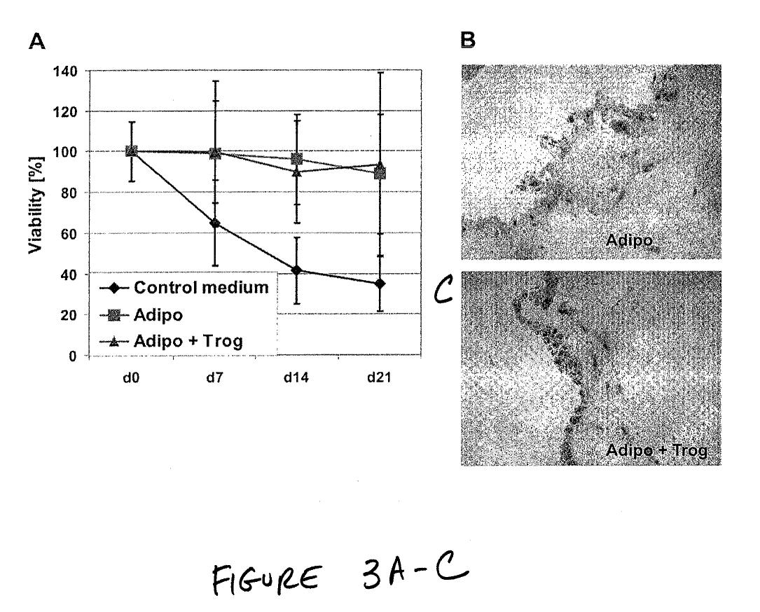

Viability remained constant in adipogenic media during the whole cultivation period of three weeks, whereas it dropped to about 40% in control medium (DMEM-HG, 2 mM L-Gln, 10% FCS; FIG. 3A). The decrease in viability in control medium might be due to cell death, as the membrane folded up and formed a tight aggregate only in control medium and not in adipogenic medium, which might render cells within amniotic membrane inaccessible by nutrients.

Alternatively or additionally, the aggregation of amniotic membrane might hinder ez4u-assay reagents to target living cells, which would result in a lower ez4u signal. Cryosections were prepared after three weeks cultivation, which showed lipid droplets in amniotic membrane cultivated in adipogenic medium (FIG. 3B) and strongly enhanced lipid-vesicle formation in adipogenic medium containing troglitazone (FIG. 3C).

4) Combination of Differentiated Amniotic Membrane with Scaffolds: Wrap Around Technology

Undifferentiated, predifferentiated, or differentiated amnion can be combined with biologically and/or synthetically produced scaffolds, e.g. Sponceram or Collagraft. Amniotic membrane can be wrapped around these scaffolds in a way that precursor cells from amniotic membrane will migrate into the pores of the scaffold and adhere. These scaffolds will intensify differentiation through their osteoinductive properties and improve the initial mechanical characteristics upon transplantation.

5) Combination of Amniotic Membrane Layers Differentiated Along Various Lineages and of Amniotic Membrane with Vascular Structures

As viability of cells within tissue engineering constructs strongly depends on their supply with nutrients and oxygen, sufficient vascularization is needed for application of these constructs in vivo, if they exceed critical geometric dimensions (Nomi et al., 2002). Therefore, native, predifferentiated or differentiated amniotic membrane can be combined with vascular structures.

These may be fabricated by decellularization of various tissues, e.g. small intestine submucosa (Schultheiss et al., 2005; Mertsching et al., 2005), or human placenta (Hopper et al., 2003; Flynn et al., 2006) and reseeded with autologous endothelial progenitor cells (from peripheral blood (Allan et al., 2007) or from adipose tissue) or with predifferentiated allogeneic human amniotic mesenchymal stromal cells (Alviano et al., 2007). Different layers can be connected by application of fibrin glue before in vivo transplantation. Thus, vascularized soft tissue or bone can be generated by combining vascular structures with amniotic membrane, differentiated along the adipogenic or osteogenic lineage, respectively.

### REFERENCE LIST

Adinolfi, M., Akle, C. A., McColl, I., Fensom, A. H., Tansley, L., Connolly, P., Hsi, B. L., Faulk, W. P., Travers, P., and Bodmer, W. F. (1982). Expression of HLA antigens, beta 2-microglobulin and enzymes by human amniotic epithelial cells. Nature 295, 325-327.
Akle, C. A., Adinolfi, M., Welsh, K. I., Leibowitz, S., and McColl, I. (1981). Immunogenicity of human amniotic epithelial cells after transplantation into volunteers. Lancet 2, 1003-1005.
Allan, D. S., Dube, P., Roy, J., Busque, L., and Roy, D. C. (2007). Endothelial-like vascular progenitor cells (VPCs) from allogeneic and autologous donors: mobilization features distinct from hematopoietic progenitors. Biol. Blood Marrow Transplant. 13, 433-439.
Alviano, F., Fossati, V., Marchionni, C., Arpinati, M., Bonsi, L., Franchina, M., Lanzoni, G., Cantoni, S., Cavallini, C., Bianchi, F., Tazzari, P. L., Pasquinelli, G., Foroni, L., Ventura, C., Grossi, A., and Bagnara, G. P. (2007). Term Amniotic membrane is a high throughput source for multipotent Mesenchymal Stem Cells with the ability to differentiate into endothelial cells in vitro. BMC. Dev. Biol. 7, 11.
Arora, M., Jaroudi, K. A., Hamilton, C. J., and Dayel, F. (1994). Controlled comparison of interceed and amniotic membrane graft in the prevention of postoperative adhesions in the rabbit uterine horn model. Eur. J. Obstet. Gynecol. Reprod. Biol. 55, 179-182.
Dhall, K. (1984). Amnion graft for treatment of congenital absence of the vagina. Br. J. Obstet. Gynaecol. 91, 279-282.
Dua, H. S., Gomes, J. A., King, A. J., and Maharajan, V. S. (2004). The amniotic membrane in ophthalmology. Surv. Ophthalmol. 49, 51-77.
Faulk, W. P., Matthews, R., Stevens, P. J., Bennett, J. P., Burgos, H., and Hsi, B. L. (1980). Human amnion as an adjunct in wound healing. Lancet 1, 1156-1158.
Fedorovich, N. E., Alblas, J., de, W., Jr., Hennink, W. E., Verbout, A. J., and Dhert, W. J. (2007). Hydrogels as extracellular matrices for skeletal tissue engineering: state-of-the-art and novel application in organ printing. Tissue Eng 13, 1905-1925.
Flynn, L., Semple, J. L., and Woodhouse, K. A. (2006). Decellularized placental matrices for adipose tissue engineering. J. Biomed. Mater. Res. A 79, 359-369.
Gajiwala, K. and Gajiwala, A. L. (2004). Evaluation of lyophilised, gamma-irradiated amnion as a biological dressing. Cell Tissue Bank. 5, 73-80.
Ganatra, M. A. (2003). Amniotic membrane in surgery. J. Pak. Med. Assoc. 53, 29-32.
Gomes, J. A., Romano, A., Santos, M. S., and Dua, H. S. (2005). Amniotic membrane use in ophthalmology. Curr. Opin. Ophthalmol. 16, 233-240.
Gruss, J. S. and Jirsch, D. W. (1978). Human amniotic membrane: a versatile wound dressing. Can. Med. Assoc. J. 118, 1237-1246.
Hao, Y., Ma, D. H., Hwang, D. G., Kim, W. S., and Zhang, F. (2000). Identification of antiangiogenic and antiinflammatory proteins in human amniotic membrane. Cornea 19, 348-352.
Hennerbichler, S., Reichl, B., Pleiner, D., Gabriel, C., Eibl, J., and Redl, H. (2006). The influence of various storage conditions on cell viability in amniotic membrane. Cell Tissue Bank.
Hopper, R. A., Woodhouse, K., and Semple, J. L. (2003). Acellularization of human placenta with preservation of the basement membrane: a potential matrix for tissue engineering. Ann. Plast. Surg. 51, 598-602.
Hoyes, A. D. (1970). Ultrastructure of the mesenchymal layers of the human amnion in early pregnancy. Am. J. Obstet. Gynecol. 106, 557-566.
Mano, J. F., Silva, G. A., Azevedo, H. S., Malafaya, P. B., Sousa, R. A., Silva, S. S., Boesel, L. F., Oliveira, J. M., Santos, T. C., Marques, A. P., Neves, N. M., and Reis, R. L. (2007). Natural origin biodegradable systems in tissue engineering and regenerative medicine: present status and some moving trends. J. R. Soc. Interface.
Mertsching, H., Walles, T., Hofmann, M., Schanz, J., and Knapp, W. H. (2005). Engineering of a vascularized scaffold for artificial tissue and organ generation. Biomaterials 26, 6610-6617.
Miki, T., Lehmann, T., Cai, H., Stolz, D. B., and Strom, S. C. (2005). Stem cell characteristics of amniotic epithelial cells. Stem Cells 23, 1549-1559.
Miyahara, Y., Nagaya, N., Kataoka, M., Yanagawa, B., Tanaka, K., Hao, H., Ishino, K., Ishida, H., Shimizu, T., Kangawa, K., Sano, S., Okano, T., Kitamura, S., and Mori, H. (2006). Monolayered mesenchymal stem cells repair scarred myocardium after myocardial infarction. Nat. Med. 12, 459-465.
Nisolle, M. and Donnez, J. (1992). Vaginoplasty using amniotic membranes in cases of vaginal agenesis or after vaginectomy. J. Gynecol. Surg. 8, 25-30.
Nomi, M., Atala, A., Coppi, P. D., and Soker, S. (2002). Principals of neovascularization for tissue engineering. Mol. Aspects Med. 23, 463-483.
Parolini, O., Alviano, F., Bagnara, G. P., Bilic, G., Buhring, H. J., Evangelista, M., Hennerbichler, S., Liu, B., Magatti, M., Mao, N., Miki, T., Marongiu, F., Nakajima, H., Nikaido, T., Portmann-Lanz, C. B., Sankar, V., Soncini, M., Stadler, G., Surbek, D., Takahashi, T. A., Redl, H., Sakuragawa, N., Wolbank, S., Zeisberger, S., Zisch, A., and Strom, S. C. (2007). CONCISE REVIEW: Isolation and Characterization of Cells from Human Term Placenta: Outcome of the First International Workshop on Placenta Derived Stem Cells. Stem Cells.
Portmann-Lanz, C. B., Schoeberlein, A., Huber, A., Sager, R., Malek, A., Holzgreve, W., and Surbek, D. V. (2006). Placental mesenchymal stem cells as potential autologous graft for pre- and perinatal neuroregeneration. Am. J. Obstet. Gynecol. 194, 664-673.
Rennekampff, H. O., Dohrmann, P., Fory, R., and Fandrich, F. (1994). Evaluation of amniotic membrane as adhesion prophylaxis in a novel surgical gastroschisis model. J. Invest Surg. 7, 187-193.
Sakuragawa, N., Kakinuma, K., Kikuchi, A., Okano, H., Uchida, S., Kamo, I., Kobayashi, M., and Yokoyama, Y. (2004). Human amnion mesenchyme cells express phenotypes of neuroglial progenitor cells. J. Neurosci. Res. 78, 208-214.
Sakuragawa, N., Yoshikawa, H., and Sasaki, M. (1992). Amniotic tissue transplantation: clinical and biochemical evaluations for some lysosomal storage diseases. Brain Dev. 14, 7-11.
Scaggiante, B., Pineschi, A., Sustersich, M., Andolina, M., Agosti, E., and Romeo, D. (1987). Successful therapy of Niemann-Pick disease by implantation of human amniotic membrane. Transplantation 44, 59-61.
Schultheiss, D., Gabouev, A. I., Cebotari, S., Tudorache, I., Walles, T., Schlote, N., Wefer, J., Kaufmann, P. M., Haverich, A., Jonas, U., Stief, C. G., and Mertsching, H. (2005). Biological vascularized matrix for bladder tissue engineering: matrix preparation, reseeding technique and short-term implantation in a porcine model. J. Urol. 173, 276-280.
Subrahmanyam, M. (1995). Amniotic membrane as a cover for microskin grafts. Br. J. Plast. Surg. 48, 477-478.
Tosi, G. M., Massaro-Giordano, M., Caporossi, A., and Toti, P. (2005). Amniotic membrane transplantation in ocular surface disorders. J. Cell Physiol 202, 849-851.
Tylki-Szymanska, A., Maciejko, D., Kidawa, M., Jablonska-Budaj, U., and Czartoryska, B. (1985). Amniotic tissue transplantation as a trial of treatment in some lysosomal storage diseases. J. Inherit. Metab Dis. 8, 101-104.
Ward, D. J., Bennett, J. P., Burgos, H., and Fabre, J. (1989). The healing of chronic venous leg ulcers with prepared human amnion. Br. J. Plast. Surg. 42, 463-467.
Wolbank, S., Peterbauer, A., Fahrner, M., Hennerbichler, S., van Griensven, M., Stadler, G., Redl, H., and Gabriel, C. (2007). Dose-Dependent Immunomodulatory Effect of Human Stem Cells from Amniotic Membrane: A Comparison with Human Mesenchymal Stem Cells from Adipose Tissue. Tissue Eng 13, 1173-1183.
Yang, J., Yamato, M., Nishida, K., Ohki, T., Kanzaki, M., Sekine, H., Shimizu, T., and Okano, T. (2006). Cell delivery in regenerative medicine: the cell sheet engineering approach. J. Control Release 116, 193-203.
Yeager, A. M., Singer, H. S., Buck, J. R., Matalon, R., Brennan, S., O'Toole, S. O., and Moser, H. W. (1985). A therapeutic trial of amniotic epithelial cell implantation in patients with lysosomal storage diseases. Am. J. Med. Genet. 22, 347-355.
Young, R. L., Cota, J., Zund, G., Mason, B. A., and Wheeler, J. M. (1991). The use of an amniotic membrane graft to prevent postoperative adhesions. Fertil. Steril. 55, 624-628.
Zhao, P., Ise, H., Hongo, M., Ota, M., Konishi, I., and Nikaido, T. (2005). Human amniotic mesenchymal cells have some characteristics of cardiomyocytes. Transplantation 79, 528-535.
Zohar, Y., Talmi, Y. P., Finkelstein, Y., Shvili, Y., Sadov, R., and Laurian, N. (1987). Use of human amniotic membrane in otolaryngologic practice. Laryngoscope 97, 978-980.

Various references are cited herein, the contents of which are hereby incorporated by reference in their entireties.

1) Sterile, virally safe, heterologous, homologous, isologous or autologous tissue, tissue-typed or not tissue-typed, which contains predifferentiated and/or differentiable sessile stem cells and which can be used for wound closure and/or promotion of wound healing.

2) Tissue according to claim 1 which can be used in tissue engineering.

3) Tissue according to claim 1 which contains chondrogenic and/or osteogenic and/or adipogenic and/or angiogenic precursor cells and/or neuro precursor cells.

4) Tissue according to claim 1 to which substances are added in culture medium for the differentiation of stem cells or predifferentiated stem cells.

5) Tissue according to claim 1, in which no animal additives are used in the culture medium.

6) Tissue according to claim 1, in which the adipogenic differentiation is supported by agonists of the peroxisome proliferators-activated receptor.

7) Tissue according to claim 1 which undergoes differentiation of stem cells or predifferentiated stem cells by physical action such as stretching, compressing, fluid flow, electrical, ultrasound, and/or shock wave treatment.

8) Tissue according to claim 1 which is transfected prior to, during, or after differentiation of stem cells.

9) Tissue according to claim 1 which is used for the construction of three-dimensional cell layers, where the latter may be used as such or may be combined by a provisional matrix.

10) Tissue according to claim 2 which is used for the construction of three-dimensional cell layers, where the latter may be used as such or may be combined by a provisional matrix.

11) Tissue according to claim 1 which is used in combination with biologically and/or synthetically produced scaffolds.

12) Tissue according to claim 1 which is used for lining tube- or cavity-like parts of organs or constructs obtained by tissue engineering.
